(19) United States
(12) Patent Application Publication
(10) Pub. No.: US 2023/0284347 A1
(43) Pub. Date: Sep. 7, 2023

(54) INDUCTION HEATING APPARATUS AND METHOD FOR CONTROLLING INDUCTION HEATING APPARATUS

(71) Applicants: LG ELECTRONICS INC., Seoul (KR); UNIST(ULSAN NATIONAL INSTITUTE OF SCIENCE AND TECHNOLOGY), Ulsan (KR)

(72) Inventors: Jee Hoon JUNG, Ulsan (KR); Gwangrok Kim, Seoul (KR); Hyunjun Choi, Seoul (KR); Kyung Wook Heo, Ulsan (KR); Geunwook Kim, Ulsan (KR)

(21) Appl. No.: 18/118,266

(22) Filed: Mar. 7, 2023

(30) Foreign Application Priority Data
Mar. 7, 2022 (KR) 10-2022-0028939

(51) Int. Cl. H05B 6/06

(52) U.S. Cl. CPC H05B 6/062; H05B 2213/07

(57) ABSTRACT

A method for controlling an induction heating apparatus according to one embodiment includes receiving a heating start command; determining whether or not to perform a temperature correction operation based on a difference between a current driving start time point of a working coil and a previous driving end time point of the working coil; obtaining an equivalent resistance value of the working coil and a container placed on the working coil by driving the working coil at a preset reference frequency, when it is determined to perform the temperature correction operation; obtaining a temperature correction value based on the equivalent resistance value; obtaining a temperature value sensed by a temperature sensor; and correcting the temperature value based on the temperature correction value.

### CROSS-REFERENCE TO RELATED APPLICATION

This application claims priority to and the benefit of Korean Patent Application No. 10-2022-0028939, filed on Mar. 7, 2022, the disclosure of which is incorporated herein by reference in its entirety.

### TECHNICAL FIELD

The present disclosure relates to an induction heating apparatus and a method for controlling the induction heating apparatus.

### BACKGROUND

An induction heating apparatus heats a container by using an induction heating method. When electric energy is supplied to a working coil provided in an induction heating apparatus, a magnetic field is generated around the working coil. Then the magnetic field may generate eddy currents in a container provided on the working coil, to heat the container.

A temperature sensor is disposed at the center of the working coil. When the container placed on the working coil is heated, a temperature value may be obtained by the temperature sensor. The temperature value sensed by the temperature sensor during the heating of the container may be transmitted to a controller. The controller may stop the heating of the container when a temperature value sensed by the temperature sensor or a change rate of the temperature value exceeds a preset reference value. Accidents due to overheating of the container may be prevented by this overheating prevention operation.

The temperature sensor is disposed at the center of the working coil and an upper plate is provided on the working coil so that a container may be provided on the upper plate. Accordingly, the temperature sensor obtained by the temperature sensor is a value reflecting not only the temperature of the container but also the temperature of the working coil. In order to properly perform the above-mentioned overheat prevention operation, it is necessary to exclude the temperature of the working coil and obtain only the accurate temperature value of the container.

### SUMMARY

One objective of the present disclosure is to provide an induction heating apparatus that may obtain an accurate temperature value of a container by excluding the temperature of a working coil from a temperature value obtained by a temperature sensor, and a method for controlling the induction heating apparatus.

A further object of the present disclosure is to provide an induction heating apparatus that may reduce a possibility of accident occurrence due to overheating of a container by performing a heating protection operation based on an accurate temperature value, and a method for controlling the induction heating apparatus.

Aspects according to the present disclosure are not limited to the above ones, and other aspects and advantages that are not mentioned above can be clearly understood from the following description and can be more clearly understood from the embodiments set forth herein.

In embodiments of the present disclosure, a method for controlling an induction heating apparatus may include receiving a heating start command; determining whether or not to perform a temperature correction operation based on a difference between a current driving start time point of a working coil and a previous driving end time point of the working coil; obtaining an equivalent resistance value of the working coil and a container placed on the working coil by driving the working coil at a preset reference frequency, when it is determined to perform the temperature correction operation; obtaining a temperature correction value based on the equivalent resistance value; obtaining a temperature value sensed by a temperature sensor; and correcting the temperature value based on the temperature correction value.

The determining whether or not to perform the temperature correction operation based on the difference between the current driving start time point of the working coil and the previous driving end time point of the working coil may include determining to perform the temperature correction operation when the difference is smaller than a preset reference value; and determining not to perform the temperature correction operation when the difference is equal to the reference value.

The obtaining the temperature correction value based on the equivalent resistance value may include obtaining a temperature correction value corresponding to the equivalent resistance value based on a table including a plurality of equivalent resistance values and a plurality of temperature corrections values corresponding to the plurality of equivalent resistance values, respectively.

The table may be made based on a temperature value of a container and an equivalent resistance value of the working coil and the container corresponding to the temperature value of the container, and a temperature value of the container measured when the temperature of the working coil is a second temperature value and an equivalent resistance value of the working coil and the container corresponding to the temperature value of the container.

The temperature correction value may be an average value of a plurality of temperature correction values obtained when the working coil is driven at a plurality of driving frequencies.

The method for controlling the induction heating apparatus may further include determining not to perform the temperature correction operation, when the temperature value sensed by the temperature sensor is greater than a preset limit temperature value.

In an embodiment, an induction heating apparatus may include a working coil; a temperature sensor disposed at the center of the working coil; a power supply circuit configured to supply power for driving the working coil; and a controller configured to control the driving of the working coil by controlling driving of the power supply circuit.

The controller may determine whether or not to perform a temperature correction operation based on a difference between a current driving start time point of a working coil and a previous driving end time point of the working coil when receiving a heating start command, obtain an equivalent resistance value of the working coil and a container placed on the working coil by driving the working coil at a preset reference frequency when it is determined to perform the temperature correction operation, obtain a temperature correction value based on the equivalent resistance value, obtaining a temperature value sensed by a temperature sensor, and correcting the temperature value based on the temperature correction value.

The controller may determine to perform the temperature correction operation when the difference between the current driving start time point of the working coil and the previous driving end time point of the working coil is smaller than a preset reference value, and determine not to perform the temperature correction operation when the difference is equal to the reference value.

The controller may obtain a temperature correction value corresponding to the equivalent resistance value based on a table including a plurality of equivalent resistance values and a plurality of temperature corrections values corresponding to the plurality of equivalent resistance values, respectively.

The table may be made based on a temperature value of a container and an equivalent resistance value of the working coil and the container corresponding to the temperature value of the container, and a temperature value of the container measured when the temperature of the working coil is a second temperature value and an equivalent resistance value of the working coil and the container corresponding to the temperature value of the container.

The temperature correction value may be an average value of a plurality of temperature correction values obtained when the working coil is driven at a plurality of driving frequencies.

The controller may determine not to perform the temperature correction operation, when the temperature value sensed by the temperature sensor is greater than a preset limit temperature value.

According to the present disclosure, the induction heating apparatus may obtain an accurate temperature value of a container by excluding the temperature of a working coil from a temperature value obtained by a temperature sensor, and a method for controlling the induction heating apparatus. Accordingly, a possibility of accident occurrence due to overheating of a container may be reduced by performing a heating protection operation based on an accurate temperature value, and a method for controlling the induction heating apparatus.

### BRIEF DESCRIPTION OF DRAWINGS

FIG. 1 is an exploded perspective diagram illustrating an induction heating apparatus according to one embodiment of the present disclosure;

FIG. 2 is a circuit diagram of the induction heating apparatus according to one embodiment;

FIG. 3 is a flow chart illustrating a method for controlling the induction heating apparatus according to one embodiment;

FIG. 4 is a graph to describe a method of generating a table referred to when a temperature correction value is obtained in an embodiment; and

FIG. 5 is a flow chart illustrating a method for controlling the induction heating apparatus according to another embodiment;

### DETAILED DESCRIPTION

The above-described aspects, features and advantages are specifically described hereunder with reference to the accompanying drawings such that one having ordinary skill in the art to which the present disclosure pertains can easily implement the technical spirit of the disclosure. In the disclosure, detailed descriptions of known technologies in relation to the disclosure are omitted if they are deemed to make the gist of the disclosure unnecessarily vague. Below, preferred embodiments according to the disclosure are specifically described with reference to the accompanying drawings. In the drawings, identical reference numerals can denote identical or similar components.

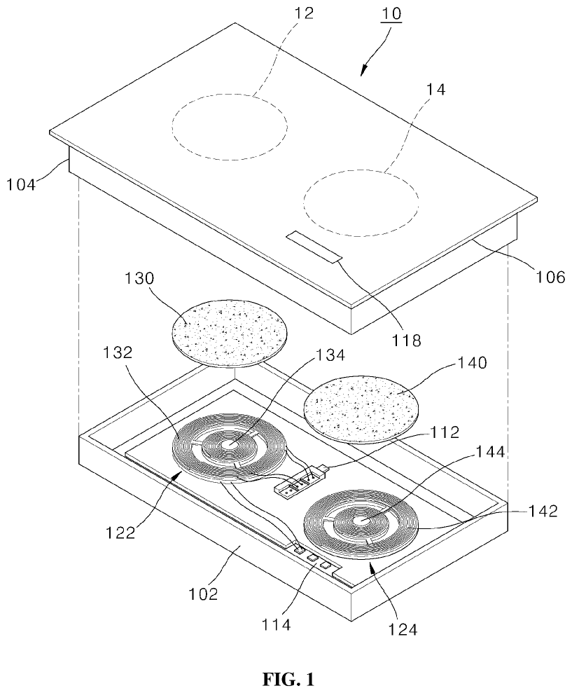

FIG. 1 is an exploded perspective diagram illustrating an induction heating apparatus according to one embodiment of the present disclosure.

The induction heating apparatus 10 according to one embodiment of the present disclosure may include a case 102 defining a body thereof and a cover plate 104 coupled to the case 102 and sealing the case 102.

The cover plate 104 may be coupled to an upper surface of the case to close the space formed in the case 102 from the outside. The cover plate 104 may include a top plate 106 on which an object to be heated (i.e., a container for cooking food) is placed. The top plate 106 may be made of a tempered glass material such as ceramic glass, but is not limited thereto. The material of the top plate 106 may vary according to embodiments.

Heating regions 12 and 14 corresponding to working coil assemblies 122 and 124, respectively, may be formed in the top plate 106. Lines or figures corresponding to the heating regions 12 and 14 may be printed or displayed on the top plate 106 in order for a user to clearly recognize the positions of the heating regions 12 and 14.

The case 102 may have a hexahedral shape with an open top. The working coil assembly 122 and 124 for heating a container or vessel may be disposed in the space formed inside the case 102. In addition, an interface unit 114 may be provided inside the case 102 and have functions to adjust a power level of each heating region 12 and 14 and display related information to the induction heating apparatus 10. The interface unit 114 may be a touch panel that is capable of both inputting information and displaying information by touch, but the interface unit 114 having a different structure may be provided according to embodiments.

A manipulation region 118 may be formed in a position corresponding to the interface unit 108 in the top plate 106. For user manipulation, characters or images may be printed on the manipulation region 118. The user may perform a desired operation by touching a specific point of the manipulation region 118 with reference to the characters or images pre-printed on the manipulation region 118.

The user may set the power level of each heating region 12 and 14 through the interface 114.

The power level may be indicated by a number (e.g., 1, 2, 3, . . . , 9) on the manipulation region 118. When the power level for each heating region 12 and 14 is set, the required power value and the heating frequency of the working coil assemblies responding to the respective heating regions 12 and 14 may be determined. A controller may drive each working coil so that the actual output power value can match the required power value set by the user based on the determined heating frequency.

In the space formed inside the case 102 may be further provided a power source part 112 for supplying power to the working coil assemblies 122 and 124 or the interface unit 114.

In the embodiment of FIG. 1, two working coil assemblies (i.e., a first working coil assembly 122 and a second working coil assembly 124) are disposed inside the case 102. However, three or more working coil assemblies may be provided in the case 102 according to embodiments. Each working coil assembly 122 and 124 may include a working coil configured to an induced magnetic field using a high frequency alternating current supplied by the power source part 112, and an insulating sheet configured to protect the coil from heat generated by the container. For example, the first working coil 122 shown in FIG. 1 may include a first working coil 132 for heating the container put in the first heating region 12 and a first insulating sheet 130. Although not shown in the drawings, the second working coil 124 may include a second working coil and a second insulating sheet. The insulating sheet may not be provided according to embodiments.

In addition, a temperature sensor may be provided at the center of each working coil. For example, a first temperature sensor 134 may be provided at the center of the first working coil 134 and a second temperature sensor 144 may be disposed at the center of the second working coil 142 as shown in FIG. 1. A value sensed by the temperature sensor may be transmitted to a controller and the controller may obtain a temperature sensor based on the sensed value. In one embodiment of the present disclosure, the temperature sensor may be a thermistor temperature sensor having a variable resistance of which a resistance value changes according to the temperature of the container, but is not limited thereto.

In the embodiment, the temperature sensor may output a sensing voltage corresponding to the temperature of the container and the sensing voltage output from the temperature sensor may be transmitted to the controller. The controller may check the temperature of the container based on the magnitude of the sensing voltage output from the temperature sensor. When the temperature of the container is a preset reference value or more, the controller may perform an overheat protection operation of lowering the actual power value of the working coil or stopping the driving of the working coil.

Although not shown in FIG. 1, a circuit board on which a plurality of circuits or elements including the controller may be disposed in the space formed inside the case 102. The controller may be a microprocessor or a logical electrical circuit.

The controller may perform a heating operation by driving each working coil 132 and 142 based on the user's heating start command input through the interface unit 114. When the user inputs a heating terminating command through the interface unit 114, the controller may stop the driving of the working coils 132 and 142 to terminate the heating operation.

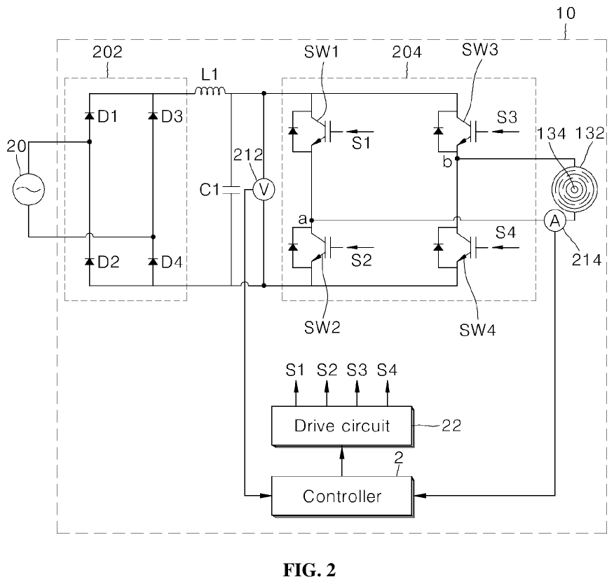

FIG. 2 is a circuit diagram of the induction heating apparatus according to one embodiment.

The induction heating apparatus 10 according to one embodiment may include a rectifier circuit 202, a smoothing circuit L1 and C1, an inverter circuit 204, a working coil 132, a controller 2 and a drive circuit 22.

The rectifier circuit 202 may include a plurality of diodes D1, D2, D3 and D4. As shown in FIG. 2, the rectifier circuit 202 may be a bridge diode circuit and it may be another type circuit according to embodiments. The rectifier circuit 202 may be configured rectify the AC input voltage supplied from the power source 20, thereby outputting a voltage having a pulsating waveform.

The smoothing circuit L1 and C1 may smooth the voltage rectified by the rectifier circuit 32 and output a DC link voltage. The smoothing circuit L1 and C1 may include a first inductor L1 and a DC link capacitor C1.

The voltage sensor 212 may sense the magnitude of the voltage output from the DC link capacitor C1 and transmit the sensed voltage value to the controller 2.

The current sensor 214 may sense the magnitude of the current output from the inverter circuit 204 and transmit the sensed current value to the controller 2.

The controller 2 may calculate a resistance value based on a voltage value measured by the voltage sensor 212 and a current value measured by the current sensor 214 when the container is heated. The controller 2 may perform an overheating prevention operation for preventing overheating of the container based on the calculated resistance value and temperature value obtained by the temperature sensor 134.

The inverter circuit (or an inverter) 204 may include a first switching element SW1, a second switching element SW2, a third switching element SW3 and a fourth switching element SW4. As shown in FIG. 2, the inverter circuit 204 of the induction heating apparatus 10 according to one embodiment of the present disclosure may be configured as a full-bridge circuit including four switching elements SW1, SW2, SW3 and SW4. However, in another embodiment of the present disclosure, the inverter circuit 204 may be configured as a half-bridge circuit including two switching elements.

The rectifier circuit 202, the smoothing circuit L1 and C1, and the inverter circuit 204 may be referred to as a power supply circuit. That is, the power supply circuit may include the rectifier circuit 202, the smoothing circuit L1 and C1, and the inverter circuit 204.

The first switching element SW1, the second switching element SW2, the third switching element SW3 and the fourth switching element SW4 may be turned on and off by a first switching signal S1, a second switching signal S2, a third switching signal S3 and a fourth switching signal S4, respectively. Each of the switching elements SW1, SW2, SW3 and SW4 may be turned on when each of the switching signals S1, S2, S3 and S4 is at a high level, and each of the switching elements SW1, SW2, SW3 and SW4 may be turned off when each of the switching signals S1, S2, S3 and S4 is at a low level.

In the embodiment of FIG. 2, each of the switching elements SW1, SW2, SW3, and SW4 is an IGBT element, but each of the switching elements SW1, SW, 2, SW3 and SW4 may be a different type of a switching elements (e.g., BJT or FET, etc) according to embodiments.

Any of the switching elements SW1, SW2, SW3 and SW4 may be turned on and off to complement each other. For example, in any one of the operation modes, the second switching element SW2 may be turned off (turned on) while the first switching element SW1 is turned on (turned off).

In addition, any of the switching elements SW1, SW2, SW3 and SW4 may be turned on and off in the same manner as each other. For example, in any of the operation modes, the first switching element SW1 may be turned on and off at the same timing as that of the third switching element SW3.

The DC link voltage input to the inverter circuit 204 may be converted into the AC link voltage by the turned-on and turned-off, that is, the switching operation of the switching elements SW1, SW2, SW3 and SW4 provided in the inverter circuit 204. The AC current converted by the inverter circuit 204 may be supplied to the working coil 132.

In an embodiment, the first switching signal S1, the second switching signal S2, the third switching signal S3 and the fourth switching signal S4 may be pulse width modulation (PWM) signals each having a predetermined duty cycle. However, the first switching signal S1, the second switching signal S2, the third switching signal S3, and the fourth switching signal S4 may be other types of signals.

When the AC current output from the inverter circuit 204 is supplied to the working coil 132, the working coil 132 may be driven. While eddy current flows through the container put on the working coil, with the driving of the working coil 132, the container may be heated. The amount of thermal energy supplied to the container may vary based on the amount of power actually generated by the driving of the working coil, that is, the actual output power value of the working coil.

When the user changes a current state of the induction heating apparatus 10 into a power on state by manipulating the interface unit of the induction heating apparatus, the input power source supply power to the induction heating apparatus 10 and the induction heating apparatus may enter a driving standby state. Hence, the user may put a container on the working coil and set a power level for the container to input a heating start command for the working coil. Once the user input the heating start command, a power value required for the working coil, that is, a required power value may be determined based on the power level set by the user.

When receiving the heating start command, the controller 2 may determine a frequency corresponding to the required power value of the working coil 132, that is, a heating frequency, and supply a control signal corresponding to the determined heating frequency to the drive circuit 22. Accordingly, switching signals S1, S2, S3 and S4 may be output from the drive circuit 22. As the switching signals S1, S2, S3 and S4 are input to the switching elements SW1, SW2, SW3 and SW4, respectively, the working coil 132 may be driven. Once the working coil 132 is driven, an eddy current may flow through the container and the container may be then heated.

In embodiment of the present disclosure, the controller 2 may determine a heating frequency corresponding to the power level set for the heating region. For example, when the user sets a power level for the heating region, the controller 2 may gradually lower the driving frequency of the inverter circuit 204 until the output power value of the working coil 132 in a state where the driving frequency of the inverter circuit 204 is set to a predetermined reference frequency matches the required power value corresponding to the power level set by the user. The controller 2 may determine a frequency detected when the output power value of the working coil 132 matches the required power value as the heating frequency.

The controller 2 may supply a control signal corresponding to the determined heating frequency to the drive circuit 22. The drive circuit 22 may output switching signals S1, S2, S3 and S4 having a duty ratio corresponding to the heating frequency determined by the controller 2 based on the control signal output from the controller 2. While the switching elements SW1, SW2, SW3 and SW4 are turned on and off complementary to each other in response to the input of the switching signals S1, S2, S3 and S4, the alternating current may be supplied to the working coil 132.

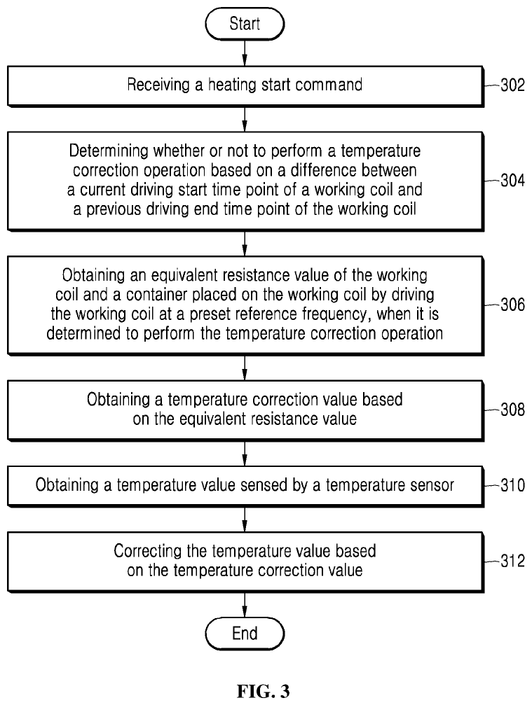

FIG. 3 is a flow chart illustrating a method for controlling the induction heating apparatus according to one embodiment. The flow chart may be performed by a controller which is executing instructions stored in a memory device such as a semiconductor memory.

When the user sets a power level through the interface unit 114, a heating start command for the working coil 132 may be received (302).

Once the heating start command is received, the controller 2 may calculate a difference between a current driving start point of the working coil 132 and the previous driving end point of the working coil 132, and determine whether to perform a temperature correction operation based on the calculated difference (304).

When the working coil 132 is maintained in a non-driven state for a preset time period (e.g., 30 minutes), the temperature of the working coil 132 may be maintained at room temperature. When the container is heated by driving the working coil 132 in the non-driven state for a preset time period (e.g., 30 minutes), the temperature value obtained by the temperature sensor 134 may proportionally rise corresponding to the temperature of the container.

Since the working coil 132 is also heated by heating the container during the driving of the working coil 132, the temperature of the working coil 132 may rise. Accordingly, when the working coil 132 re-starts the driving at a time point when a predetermined time has not elapsed (e.g., 30 minutes) since the driving end of the working coil 132, the temperature value obtained by the temperature sensor 134 may reflect the temperature of the working coil 132. And the temperature value obtained by the temperature sensor 134 may be a value higher than the actual temperature of the container.

Accordingly, when the working coil 132 re-starts the driving at a time point when a predetermined time has not elapsed (e.g., 30 minutes) since the driving end of the working coil 132, the temperature value obtained by the temperature sensor 134 could not accurately reflect the actual temperature of the container and the overheat protection operation could not be properly performed.

To solve the disadvantage, the controller 2 may calculate a difference between a current driving start time point and the previous driving end time point of the working coil, and determine whether or not to perform the temperature correction operation based on the calculated difference (304).

The previous driving end time point means the time when the driving of the working coil ends before the time when the heating start command is received. The current driving start time point means the time when the heating start command is received. For example, the driving end time point of the working coil 132, that is, the previous driving end time point is 16:30 and the driving re-start time point of the working coil 132, that is, the current driving start time point is 16:50, the difference between the current driving start time and the previous driving end time is 20 minutes.

In an embodiment, the controller 2 may compare the difference between the current driving start time and the previous driving end time with a preset reference value, and determine whether or not to perform the temperature correction operation based on the result of the comparison. For example, when the difference between the previous driving end time and the current driving start time is smaller than the preset reference value (e.g., 30 minutes), the controller 2 may determine to perform the temperature correction operation. When the difference between the previous driving end time and the current driving start time is equal to or more than the preset reference value (e.g., 30 minutes), the controller 2 may determine not to perform the temperature correction operation. The reference value may be a value that may be set to be variable according to embodiments.

Once determining not to perform the temperature correction in the operation (304), the controller 2 may perform the overheat protection operation without correcting the temperature value obtained by the temperature sensor 134. However, when it is determined not to perform the temperature correction operation in (304), the controller 2 may perform the temperature correction operation including operations of (306) to (312).

More specifically, once determining to perform the temperature correction operation, the controller 2 may obtain an equivalent resistance value between the working coil 132 and the container by driving the working coil 132 at a preset reference frequency (306).

The equivalent resistance is a resistance value of load when the working coil and the container are assumed to be a single load. In other words, the equivalent resistance value is a combined resistance value of the resistance value of the working coil 132 and the resistance value of the container.

In an embodiment, the controller 2 may obtain an input voltage value Vin and an input current value Iin, which are the sizes of the input voltage and the input current input to the working coil 132 by the switching operation of the switching signals S1, S2, S3 and S4, from the voltage sensor 212 and the current sensor 214, respectively. The controller 2 may calculate the equivalent resistance value of the working coil 132 and the container based on the input voltage value Vin and the input current value Iin.

For example, when an impedance of the container is Z, a relationship Z=Vin/Iin holds. The controller 2 may calculate the phase of the input voltage value Vin with respect to the input current value Iin (or the phase of the impedance Z) φ according to the following [Equation 1].

Φ=arctan(Im(Z)/Re(Z)) [Equation 1]

In [Equation 1], Im(Z) and Re(Z) means an imaginary part and a rear part of the impedance Z, respectively. The controller 2 may calculate the phase of φ of the impedance Z using arcsin or acrcos instead of arctan according to embodiments.

The controller 2 may calculate an effective power value We of the container according to [Equation 2].

We=Re(Vin×Iin*)/2 [Equation 2]

The controller 2 may calculate an effective value Ie of a current flowing in the container according to [Equation 3].

Ie=\sqrt{Iin×Iin*}/\sqrt{2}[Equation 3]

In [Equation 2] and [Equation 3], Iin* means a complex conjugate of Iin.

The controller 2 may calculate an equivalent resistance value R of the container and an equivalent resistance value of the working coil 132.

R=We/Ie² [Equation 4]

However, the process of determining the equivalent resistance value of the working coil 132 and the container based on [Equation 1] to [Equation 4] is one of examples. The controller 2 may calculate the equivalent resistance value based on other well-known methods and circuit configuration.

When obtaining the equivalent resistances value of the working coil 132 and the container, the controller 2 may obtain a temperature correction value based on the obtained equivalent resistance value (308).

In an embodiment, the controller 2 may obtain a temperature correction value corresponding to the equivalent resistance value based on a table including a plurality of equivalent resistance values and a plurality of temperature correction values corresponding to the plurality of equivalent resistance values. The table may be the data stored in a memory device such as a semiconductor memory.

For example, the controller 2 may obtain a temperature correction value corresponding to the equivalent resistance value, referring to [Table 1]. The table shown in [Table 1] may include a plurality of equivalent resistance values and a plurality of temperature correction values corresponding to the plurality of equivalent resistance values, respectively.

TABLE 1

| Equivalent resistance value | Temperature correction value |
|---|---|
| ER1 | K1 |
| ER2 | K2 |
| ER3 | K3 |
| . . . | . . . |

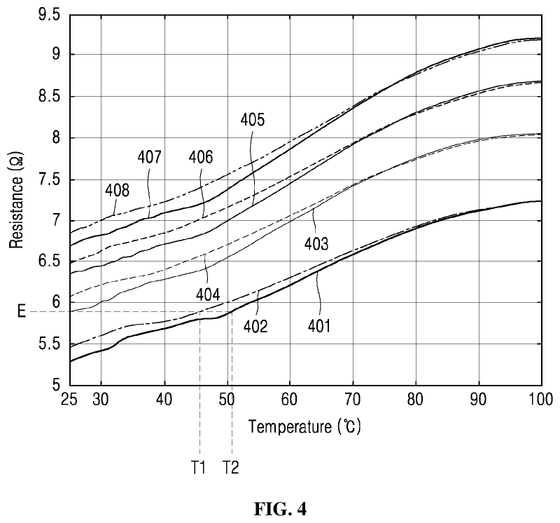

FIG. 4 is a graph to describe a method of generating a table referred to when a temperature correction value is obtained in an embodiment.

In FIG. 4, the horizontal axis represents an actual temperature value of the container measured when the container is heated by the working coil 132. The vertical axis means the equivalent resistance value of the working coil 132 and the container that is obtained by the controller 2 when the container is heated by the working coil 132.

In FIG. 4, data 401 is the data measured when the temperature of the working coil 132 is 25° C. and the working coil 132 is driven at a frequency of 38 kHz. Data 402 is the data measured when the temperature of the working coil 132 is 60° C. and the working coil 132 is driven at a frequency of 38 kHz.

In FIG. 4, Data 403 is the data measured when the temperature of the working coil 132 is 25° C. and the working coil 132 is driven at a frequency of 42 kHz. Data 404 is the data measured when the temperature of the working coil 132 is 60° C. and the working coil 132 is driven at a frequency of 42 kHz.

In FIG. 4, Data 405 is the data measured when the temperature of the working coil 132 is 25° C. and the working coil 132 is driven at a frequency of 46 kHz. Data 406 is the data measured when the temperature of the working coil 132 is 60° C. and the working coil 132 is driven at a frequency of 46 kHz.

In FIG. 4, Data 407 is the data measured when the temperature of the working coil 132 is 25° C. and the working coil 132 is driven at a frequency of 50 kHz. Data 404 is the data measured when the temperature of the working coil 132 is 60° C. and the working coil 132 is driven at a frequency of 50 kHz.

As shown in FIG. 4, when the temperature of the container is the same, the higher the temperature of the working coil 132, the greater the equivalent resistance value of the working coil 132 and the container.

In an embodiment, the table of [Table 1] may be made based on that the data 401 and the data 402, which are measured when the working coil 132 is driven at the frequency of 38 kHz. For example, in FIG. 4, the temperature correction value corresponding to the equivalent resistance value E is T2-T1. In this way, a temperature correction value corresponding to each equivalent resistance value may be calculated.

In an embodiment, the controller 2 may obtain a temperature correction value based on a plurality of tables made based on the data measured at different reference frequencies.

For example, the controller 2 may drive the working coil 132 in the operations (306) and (308) at 38 kHz, 42 kHz, 46 kHz, 50 kHz. The controller 2 may obtain four temperature correction based on a first table made based on the data 401 and the data 402 measured when the working coil 132 is driven at the frequency of 38 kHz, a second table made based on the data 403 and the data 404 measured when the working coil 132 is driven at the frequency of 42 kHz, a third table made based on the data 405 and the data 406 measured when the working coil 132 is driven at the frequency of 46 kHz, and a fourth table made based on the data 407 and the data 408 measured when the working coil 132 is driven at the frequency of 50 kHz. In the operation (310), the controller 2 may obtain an average value of the obtained four temperature correction values as a final temperature correction value.

Once obtaining the final temperature correction value, the controller may correct the temperature value obtained by the temperature sensor 134 based on the obtained temperature correction value. For example, the controller 2 may determine a value obtained by subtracting the temperature correction value from the temperature value obtained by the temperature sensor as the actual temperature value of the container.

The controller 2 may perform the overheat protection operation based on the corrected temperature value, that is, the actual temperature value of the container. For example, the controller 2 may perform the overheat protection operation of reducing an output power value of the working coil 132 or stopping the driving of the working coil 132, when the actual temperature value of the container or the rate of change of the actual temperature value is equal to or greater than a preset reference value.

In an embodiment, the controller 2 may not perform the temperature correction operation when the temperature value sensed by the temperature sensor 134 is greater than a preset limit temperature value (e.g., 70° C.). If the temperature value sensed by the temperature sensor 134 is greater than the preset limit temperature value, the temperature of the working coil 132 will not rise any further so that the overheat protection operation may be performed without correcting the temperature value sensed by the temperature sensor 134.

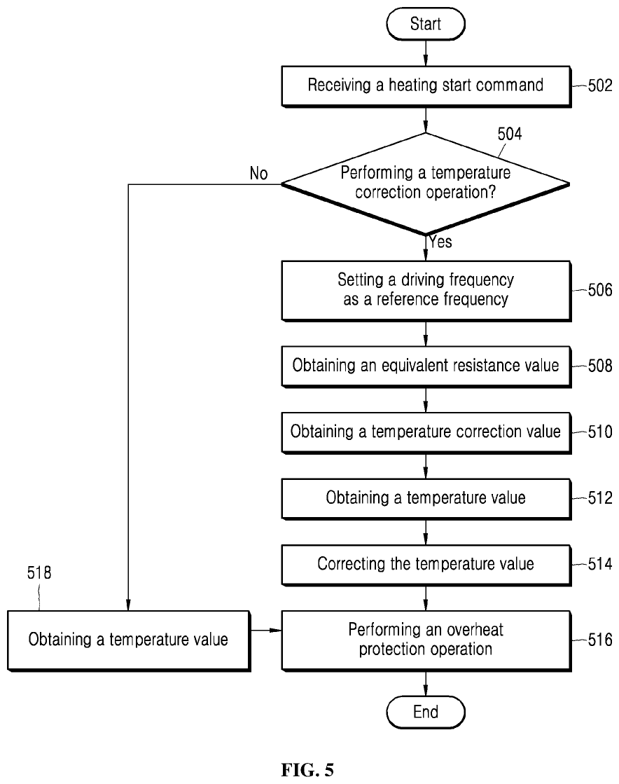

FIG. 5 is a flow chart illustrating a method for controlling the induction heating apparatus according to another embodiment. The flow chart may be performed by a controller which is executing instructions stored in a memory device such as a semiconductor memory.

When the user sets a power level through the interface unit 114, a heating start command for the working coil 132 is received (502).

Once the heating start command is received, the controller 2 may determine whether or not to perform the temperature correction operation (504).

In an embodiment, the controller 2 may calculate a difference between a current driving start time point and a previous driving end time point, and may determine whether to perform the temperature correction operation based on the calculated difference.

For example, when the difference between the previous driving end time point and the current driving start time point is smaller than a preset reference (e.g., 30 minutes), the controller 2 determine to perform the temperature correction operation. When the difference between the previous driving end time point is equal to or greater than the preset reference value (e.g., 30 minutes), the controller 2 may determine not to perform the temperature correction operation.

In another embodiment, the controller 2 may compare the temperature sensed by the temperature sensor 134 with a preset limit temperature value, and may determine whether or not to perform the temperature correction operation based on the result of the comparison.

For example, when the temperature value sensed by the temperature sensor 134 is greater than the preset limit temperature value (e.g., 70° C.), the controller 2 may determine not to perform the temperature correction operation. When the temperature value sensed by the temperature sensor 134 is equal to or smaller than the preset limit temperature value (e.g., 70° C.), the controller 2 may determine to perform the temperature correction operation.

When it is determined not to perform the temperature correction operation in the operation (504), the controller 2 may obtain the temperature value measured by the temperature sensor 134 and perform the overheat protection operation based on the obtained temperature value (516).

When it is determined to perform the temperature correction operation in the operation (504), the controller 2 may set the driving frequency of the working coil 132 as a preset reference frequency (506). The reference frequency may be set differently based on embodiments.

The controller 2 may obtain an equivalent resistance value of the working coil 132 and the container when the working coil 132 is driven at the reference frequency (508). For example, the controller 2 may obtain the equivalent resistance value of the working coil 132 and the container based on [Equation 1] to [Equation 4].

The controller 2 may obtain a temperature correction value based on the obtained equivalent resistance value (510). For example, the controller 2 may obtain a temperature correction value corresponding to the obtained equivalent resistance value based on the table of [Table 1]. In an embodiment, the controller 2 may drive the working coil 132 at a plurality of reference frequencies, and obtain a plurality of temperature correction values corresponding to the equivalent resistance value based on different tables corresponding to the reference frequencies, respectively. For example, in the operation (512), the controller 2 may determine an average value of the plurality of temperature correction values as a final temperature correction value.

The controller 2 may correct the temperature value obtained by the temperature sensor 134 based on the temperature correction vale (514). For example, the controller 2 may correct the temperature value obtained by the temperature sensor 134 by subtracting the temperature correction value from the temperature value obtained by the temperature sensor 134.

Once correcting the temperature value obtained by the temperature sensor 134, the controller 2 may perform the overheat protection operation based on the corrected temperature value (516). For example, when an actual temperature value of the container or a rate of change of the actual temperature value is equal to or greater than a preset reference value, the controller 2 may perform the overheat protection operation of reducing an output power value of the working coil 132 or stopping the driving of the working coil 132.

The embodiments are described above with reference to a number of illustrative embodiments thereof. However, the present disclosure is not intended to limit the embodiments and drawings set forth herein, and numerous other modifications and embodiments can be devised by one skilled in the art. Further, the effects and predictable effects based on the configurations in the disclosure are to be included within the range of the disclosure though not explicitly described in the description of the embodiments.

What is claimed is:

1. A method of controlling an induction heating apparatus by a controller, comprising:
determining whether or not to perform a temperature correction operation based on a difference between a current driving start time point of a working coil and a previous driving end time point of the working coil;
obtaining an equivalent resistance value of the working coil and a container placed on the working coil by driving the working coil at a reference frequency, based on the determination to perform the temperature correction operation;
obtaining a temperature correction value based on the equivalent resistance value;
obtaining a temperature value sensed by a temperature sensor; and
correcting the temperature value based on the temperature correction value.

2. The method of controlling the induction heating apparatus of claim 1, wherein the determining whether or not to perform the temperature correction operation based on the difference between the current driving start time point of the working coil and the previous driving end time point of the working coil comprises:
determining to perform the temperature correction operation based on the difference being smaller than a reference value; and
determining not to perform the temperature correction operation based on the difference being equal to or greater than the reference value.

3. The method of controlling the induction heating apparatus of claim 1, wherein the obtaining the temperature correction value based on the equivalent resistance value comprises, obtaining the temperature correction value corresponding to the equivalent resistance value based on a table including a plurality of equivalent resistance values and a plurality of temperature corrections values corresponding to the plurality of equivalent resistance values, respectively.

4. The method of controlling the induction heating apparatus of claim 3, wherein the temperature correction value of the table is based on a first temperature value of a container measured when a temperature of the working coil is a first temperature value and an equivalent resistance value of the working coil and the container corresponding to the first temperature value of the container, and a second temperature value of the container measured when the temperature of the working coil is a second temperature value and an equivalent resistance value of the working coil and the container corresponding to the second temperature value of the container.

5. The method for controlling the induction heating apparatus of claim 1, wherein the temperature correction value is an average value of a plurality of temperature correction values obtained based on the working coil being driven at a plurality of driving frequencies.

6. The method for controlling the induction heating apparatus of claim 1, further comprising:
determining not to perform the temperature correction operation based on the temperature value sensed by the temperature sensor being greater than a limit temperature value.

7. An induction heating apparatus comprising:
a working coil;
a temperature sensor to sense a temperature value of the working coil;
a power supply circuit to supply power for driving the working coil; and
a controller configured to control the driving of the working coil by controlling driving of the power supply circuit,
wherein the controller is configured to determine whether or not to perform a temperature correction operation based on a difference between a current driving start time point of a working coil and a previous driving end time point of the working coil, obtain an equivalent resistance value of the working coil and a container placed on the working coil by driving the working coil at a reference frequency based on the determination to perform the temperature correction operation, obtain a temperature correction value based on the equivalent resistance value, obtain the temperature value sensed by a temperature sensor, and correct the temperature value based on the temperature correction value.

8. The induction heating apparatus of claim 7, wherein the controller is configured to perform the temperature correction operation based on the difference between the current driving start time point of the working coil and the previous driving end time point of the working coil being smaller than a reference value, and determine not to perform the temperature correction operation based on the difference being equal to or greater than the reference value.

9. The induction heating apparatus of claim 7, wherein the controller is configured to obtain the temperature correction value corresponding to the equivalent resistance value based on a table including a plurality of equivalent resistance values and a plurality of temperature corrections values corresponding to the plurality of equivalent resistance values, respectively.

10. The induction heating apparatus of claim 9, wherein the temperature correction value of the table is based on a first temperature value of a container measured when a temperature of the working coil is a first temperature value and an equivalent resistance value of the working coil and the container corresponding to the first temperature value of the container, and a second temperature value of the container measured when the temperature of the working coil is a second temperature value and an equivalent resistance value of the working coil and the container corresponding to the second temperature value of the container.

11. The induction heating apparatus of claim 7, wherein the temperature correction value is an average value of a plurality of temperature correction values obtained based on the working coil being driven at a plurality of driving frequencies.

12. The induction heating apparatus of claim 7, wherein the controller is configured to determine not to perform the temperature correction operation, based on the temperature value sensed by the temperature sensor being greater than a limit temperature value.

13. A non-transitory controller readable medium, containing instructions therein, which when executed by a controller, perform a method comprising:
determining whether or not to perform a temperature correction operation based on a difference between a current driving start time point of a working coil and a previous driving end time point of the working coil;
obtaining an equivalent resistance value of the working coil and a container placed on the working coil by driving the working coil at a reference frequency, based on the determination to perform the temperature correction operation;
obtaining a temperature correction value based on the equivalent resistance value;
obtaining a temperature value sensed by a temperature sensor; and
correcting the temperature value based on the temperature correction value.

14. The non-transitory controller readable medium of claim 13, wherein the determining whether or not to perform the temperature correction operation based on the difference between the current driving start time point of the working coil and the previous driving end time point of the working coil comprises:
determining to perform the temperature correction operation based on the difference being smaller than a reference value; and
determining not to perform the temperature correction operation based on the difference being equal to or greater than the reference value.

15. The non-transitory controller readable medium of claim 13, wherein the obtaining the temperature correction value based on the equivalent resistance value comprises,
obtaining the temperature correction value corresponding to the equivalent resistance value based on a table including a plurality of equivalent resistance values and a plurality of temperature corrections values corresponding to the plurality of equivalent resistance values, respectively.

16. The non-transitory controller readable medium of claim 15, wherein the temperature correction value of the table is based on a first temperature value of a container measured when a temperature of the working coil is a first temperature value and an equivalent resistance value of the working coil and the container corresponding to the first temperature value of the container, and a second temperature value of the container measured when the temperature of the working coil is a second temperature value and an equivalent resistance value of the working coil and the container corresponding to the second temperature value of the container.

17. The non-transitory controller readable medium of claim 13, wherein the temperature correction value is an average value of a plurality of temperature correction values obtained based on the working coil being driven at a plurality of driving frequencies.

18. The non-transitory controller readable medium of claim 1, further comprising:
determining not to perform the temperature correction operation based on the temperature value sensed by the temperature sensor being greater than a limit temperature value.
